(19) United States
(12) Patent Application Publication
(10) Pub. No.: US 2006/0083351 A1
(43) Pub. Date: Apr. 20, 2006

(54) Method and System for Scatter Correction During Bi-Plane Imaging with Simultaneous Exposure

(75) Inventors: John Robert Lamberty, Oconomowoc, WI (US); James G. Morrow, Wauwatosa, WI (US)

Correspondence Address: ARTZ & ARTZ, P.C., 28333 TELEGRAPH RD., SUITE 250, SOUTHFIELD, MI, 48034, US

(73) Assignee: GE MEDICAL SYSTEMS GLOBAL TECHNOLOGY COMPANY, LLC, Waukesha, WI (US)

(21) Appl. No.: 10/711,983

(22) Filed: Oct. 18, 2004

(51) Int. Cl. G01N 23/201

(52) U.S. Cl. 378/86

(57) ABSTRACT

A method for x-ray scatter correction during simultaneous bi-plane imaging using digital image processing. The basic concept includes correcting the image from each plane by combining it with an image of the scatter generated from the exposures of the opposite plane in such a way that the scatter effects are removed. The correction image is formed by sampling images from the detector with only the x-ray exposure of the scatter producing plane being active. These sampled images of scatter are processed to form the scatter correction image. The scatter correction image is stored in an image memory so that it is available for combination with subsequent x-ray images to remove scatter distortion.

### TECHNICAL FIELD

The present invention relates generally to x-ray systems and more particularly to bi-plane imaging systems. The invention further relates to the generation and transfer of image data generated from bi-plane imaging in conjunction with information systems.

X-ray imaging is a method of taking pictures of the inside or internal portions of an object. (The inside or internal portions of an object are those which are not visible from the exterior of the object with a human eye unless the object is opened to expose the portion of interest.) Such objects may be a human (animal) body, baggage, or vehicles. As the x-ray beam passes through the object, it is absorbed by the varying structure thereof. In the case of a body, such structure would include the bones, tissues and fluid within the body, thereby varying resultant beam intensity. The intensity of the x-ray beam emerging from the object is measured by a device that converts x-ray beam data into a detailed picture.

A typical diagnostic x-ray system includes a gantry, a patient support, an x-ray generation subsystem, an x-ray detection subsystem, an image display, and a user interface. The gantry supports one or more x-ray sources and associated x-ray detectors. The user, interacting through the user interface, manipulates the gantry and patient support to achieve each clinically relevant x-ray view, initiates x-ray generation when required, and observes the resultant detected image on the image display.

Bi-plane imaging involves two x-ray sources and two x-ray detectors. Each source/detector pair provides a unique view of an x-ray projection through the object. The two projections may be set up orthogonal, or at any other relative angle, as required to complete the clinical procedure.

Scatter radiation is caused through the deflection of radiation or particles through any angle off the focal path.

Simultaneous bi-plane imaging includes coincident x-ray exposures on both planes. With this method, scatter radiation from the exposure on the opposite plane, is included with the radiation of the primary plane, distorting the detected image information.

For many relative projection angles, the amount of scatter radiation is significant and renders the detected primary image unacceptable for diagnosis. To avoid the negative impact of opposite plane scatter, a system known as alternate bi-plane imaging has become the accepted standard. With the alternate bi-plane method, x-ray exposures are allowed on only one plane at a time.

For series imaging, the reduction in imaging rate required to support the alternate bi-plane method is a significant impact for some diagnostic procedures. To overcome the imaging rate limitation a mechanism for the controlled interruption of x-ray detection, known as “blanking”, was developed within an image intensifier. “Blanking” the image intensifier on each plane, whenever the exposure for that plane is not active, allows the exposure on the opposite plane to take place during the image readout interval without the scatter radiation affecting the read out image. Employing the blanking capability enables the exposures on each plane to be shifted in phase resulting in an increase in the imaging rate for each plane.

One disadvantage of digital x-ray detection technology is it does not support a mechanism equivalent to the “blanking” capability of the image intensifier. Because of this, as digital x-ray detectors are introduced into bi-plane applications, the aforementioned alternate bi-plane method must be utilized, but the reduction in imaging rate makes this an inefficient solution.

The disadvantages associated with current, scanning systems have made it apparent that a new technique for scanning and data transfer is needed. The new technique should substantially negate the effects of scatter. Further, the new technique should provide improved image data for use in integrated health care information systems. The present invention is directed to these ends.

### SUMMARY OF THE INVENTION

In accordance with one aspect of the present invention, a method for scatter correction during simultaneous bi-plane digital imaging includes generating a first x-ray flux in a first imaging plane, generating a first image readout, digitally sampling a first scatter signal from the first x-ray flux in a second imaging plane, and generating a first compensation signal for the first scatter signal.

In accordance with another aspect of the present invention, a digital imaging system includes a gantry and a first x-ray source coupled to the gantry. The first x-ray source is adapted to generate a first x-ray flux and a first plane scatter signal. A second x-ray source is also coupled to the gantry and is adapted to generate a second x-ray flux and a second plane scatter signal. A first x-ray detector system is coupled to the gantry and is adapted to generate a first detector signal in response to the first x-ray flux and further adapted to generate a first scatter signal in response to the second plane scatter signal.

A second x-ray detector system is coupled to the gantry and is adapted to generate a second detector signal in response to the second x-ray flux and further adapted to generate a second scatter signal in response to the first plane scatter signal. A host computer is adapted to receive the first detector signal, the second detector signal, the first plane scatter signal, and the second plane scatter signal. The host computer is still further adapted to digitally sample the first plane scatter signal, generate a first image readout in response thereto, generate a first compensation signal for the first scatter signal, and store the first compensation signal in a first scatter correction memory.

One advantage of the present invention is that it includes a method to achieve equivalent imaging rates during simultaneous bi-plane operation which are substantially similar to those achieved during single plane operation without the need of performance improvements within the x-ray source or x-ray detector to increase the imaging rates of the alternate bi-plane method. This enables the direct application of digital detector technology into bi-plane applications.

Additionally, the invention promotes the use of simultaneous bi-plane, which is highly desirable. Alternate bi-plane has prevailed, as a result of superior image quality through the avoidance of the effects of scatter, but it can not provide simultaneous views of the object under study, which is the objective of bi-plane imaging. Only simultaneous bi-plane achieves this objective.

Additional advantages and features of the present invention will become apparent from the description that follows and may be realized by the instrumentalities and combinations particularly pointed out in the appended claims, taken in conjunction with the accompanying drawings.

### BRIEF DESCRIPTION OF THE DRAWINGS

For a more complete understanding of the invention, there will now be described some embodiments thereof, given by way of example, reference being made to the accompanying drawings, in which:

FIG. 1 is a diagram of a bi-plane diagnostic imaging system in accordance with one embodiment of the present invention;

FIG. 2 is a block diagram of FIG. 1;

FIG. 3 is a diagram of a computed tomography scanning system in accordance with another embodiment of the present invention;

FIG. 4 is a timing diagram of a method for bi-plane scanning in accordance with another embodiment of the present invention; and

FIG. 5 is a block diagram of a method for scanning an object, in accordance with another embodiment of the present invention.

### DETAILED DESCRIPTION

The present invention is illustrated with respect to a diagnostic x-ray imaging system 10 particularly suited to the medical field. The present invention is, however, applicable to various other uses that may require scanning, as will be understood by one skilled in the art, e.g. baggage scanners, vehicle scanners, moving object scanners, liquid scanners, etc.

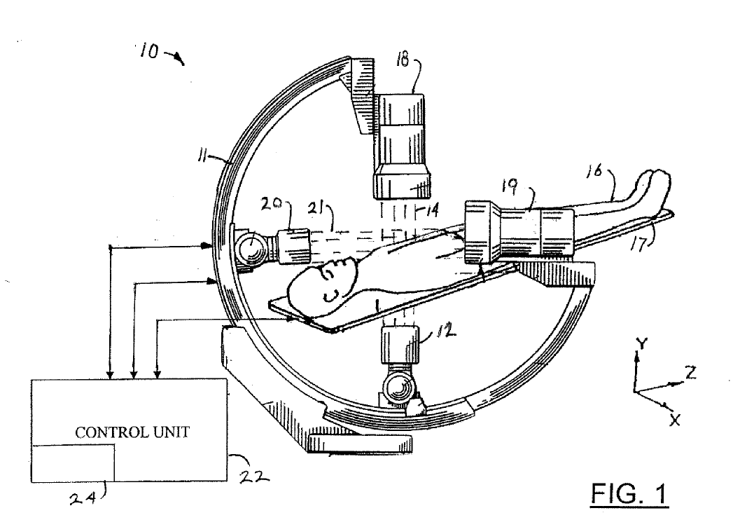

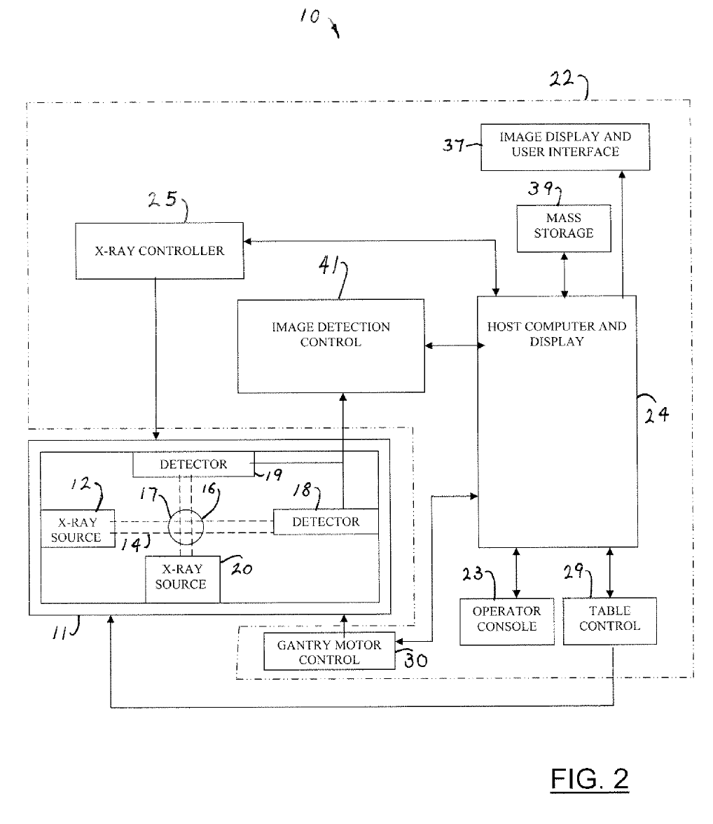

Referring to FIGS. 1, and 2, a scatter radiation compensation imaging system, including a gantry 11, in accordance with one embodiment of the present invention, is illustrated. A first x-ray source 12, coupled to the gantry 11, generates a first x-ray flux 14, which passes through an object 16 (e.g. a patient) on a table 17 and produces first scatter radiation. The system further includes a first x-ray detector 18 (first detector system), coupled to the gantry 11, which generates a detector signal in response to x-ray flux and scatter signals.

A second x-ray source 20, also coupled to the gantry 11, generates a second x-ray flux 21, which passes through the object 16 and produces second scatter radiation. The system further includes a second x-ray detector 19 (second detector system), coupled to the gantry 11, which generates a detector signal in response to x-ray flux and scatter signals.

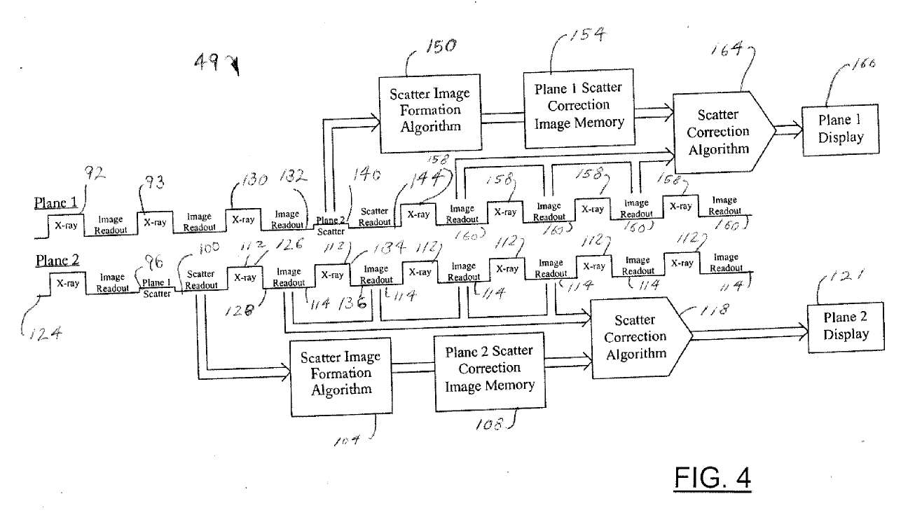

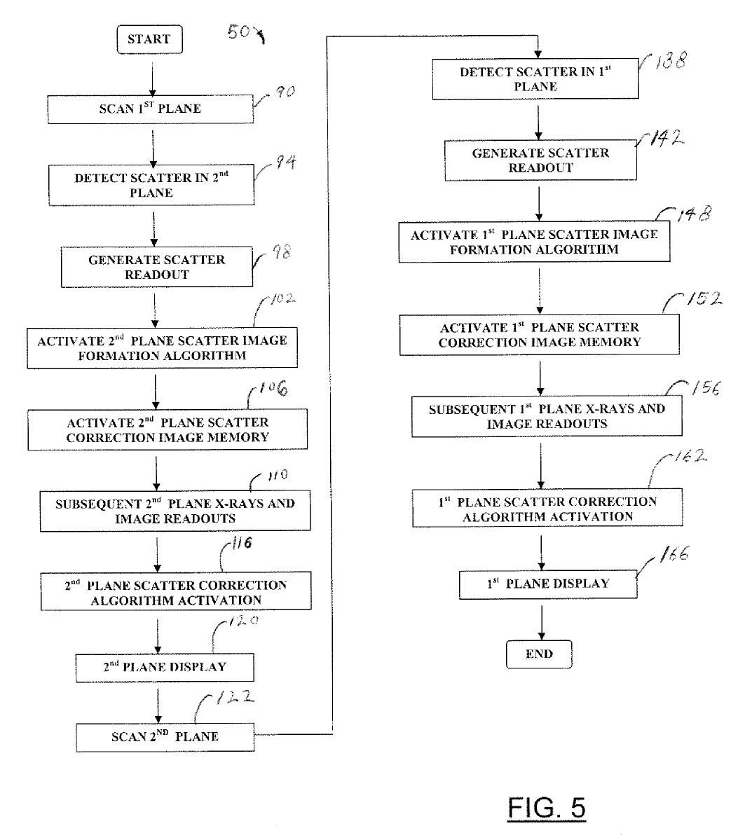

The method of compensation for the aforementioned scatter signals is discussed in detail with regard to FIGS. 4 and 5. The present system and method applies to bi-plane imaging, it is, however, applicable to numerous other imaging combinations including one, two, or three plane imaging (or other numbers of scanning planes), as will be understood by one skilled in the art.

A system control unit 22, including a host computer and display 24 and various other widely known x-ray control and display components, receives the detected primary and scatter signals and responds by generating image signals. The x-ray control unit 22 also includes, for example, an operator console 23, an x-ray controller 25, a table control 29, a gantry motor control 30, a mass storage 39, and an image detection control 41, all of which will be discussed later.

Ideally, the first x-ray source 12, first x-ray detector 18, second x-ray source 20 and second x-ray detector 19 are coupled thereto. One skilled in the art will realize that the embodied gantry 11 is merely illustrative of the numerous possible x-ray device support structures. Additionally, for imaging different objects (e.g. baggage, vehicles, patients in various positions, etc.), the relative motion and plane directions may be reoriented (e.g. move the object relative to the sources and detectors using varying types of motion (e.g. linear with a belt, arced with various shaped arc paths, etc.))

The x-ray sources 12, 20 are embodied as flat panel x-ray sources or extended x-ray sources, or standard x-ray tubes. The x-ray sources 12, 20 are activated by either the host computer 24 or the x-ray controller 25, as will be understood by one skilled in the art. The embodied method includes the x-ray sources 12, 20 activated in pulses of flux, thereby generating a first flux during an “on” phase, a subsequent image readout during an “off” phase and a subsequent flux during a subsequent “on” phase, as is illustrated in the timing diagram of FIG. 4.

The x-ray sources 12, 20 send the x-ray flux 14, 21 through an object 16 on a moveable table 27 controlled by a table control device 29 acting in response to signals from the host computer 24, as will be understood by one skilled in the art.

The first x-ray source 12 is coupled to the gantry 11 and generates a first x-ray flux 14 and a first plane scatter signal. The second x-ray source 20 is also coupled to the gantry 11 and generates a second x-ray flux 21 and a second plane scatter signal.

The x-ray flux 14, 21 from the x-ray sources 12, 20 pass through the patient and impinge on the x-ray detectors 18, 19. The signals pass to the host computer and display 24, where the signals are converted to a gray level corresponding to the attenuation of the x-ray photon through the patient, for the final x-ray image.

The x-ray detectors 18, 19 (detector systems) are typically located opposite the respective x-ray sources 12, 20 to receive x-ray flux 14, 21 and scatter radiation generated therefrom. The detectors 18, 19 include both standard x-ray detectors and scatter detectors, or alternately only x-ray detectors, receiving both x-ray and alternate plane scatter signals. In one embodiment, digital x-ray detectors are used. In an alternate embodiment of the detectors 18, 19, a mechanism that limits the detected flux to scatter signals to simplify generation of compensation signals is included, which will be discussed later.

The first x-ray detector 18 or detector system is coupled to the gantry and generates a first detector signal in response to the first x-ray flux and further generates a first scatter signal in response to second plane scatter when the second x-ray flux is off.

The second x-ray detector 19 is coupled to the gantry and generates a second detector signal in response to the second x-ray flux and further adapted to generate a second scatter signal in response to first plane scatter.

The present invention is illustrated with respect to x-ray; however it is alternately used for any type of x-ray system using detectors including mammography, vascular x-ray imaging, bone scanning, etc. Further embodiments include other non-medical applications such as weld inspection, metal inspection. Essentially, anything that could use a digital x-ray detector to make 1, 2 or 3 dimensional images.

The host computer 24 receives the detector signals and activates the x-ray sources 12, 20; however, alternate embodiments include independent activation means for the x-ray sources 12, 20. The present invention includes an operator console 23 for control of the x-ray sources 12, 20 by technicians, as will be understood by one skilled in the art.

The host computer 24 also receives the first plane scatter signal and the second plane scatter signal. The host computer 24 samples the first plane scatter signal, generates a first image readout in response thereto, generates a first compensation signal for the first scatter signal, and stores the first compensation signal in a first scatter correction memory within the host computer 24.

One embodiment of the host computer 24 includes first and second plane scatter image formation algorithms, first and second plane scatter correction image memories, first and second plane scatter correction algorithms, and displays for both planes. All of these host computer elements will be discussed in detail in regards to the timing diagram of FIG. 4 and the block diagram of FIG. 5.

Data is acquired and processed, and an x-ray image, for example, is presented to a radiology technician through the image display and user interface 37 while the exam is occurring. The host computer 24 needs only read the primary and scatter signals and update the display at the appropriate locations through, for example, an image detection controller 41. The host computer 24 alternately stores image data in a mass storage unit 39 for future reference.

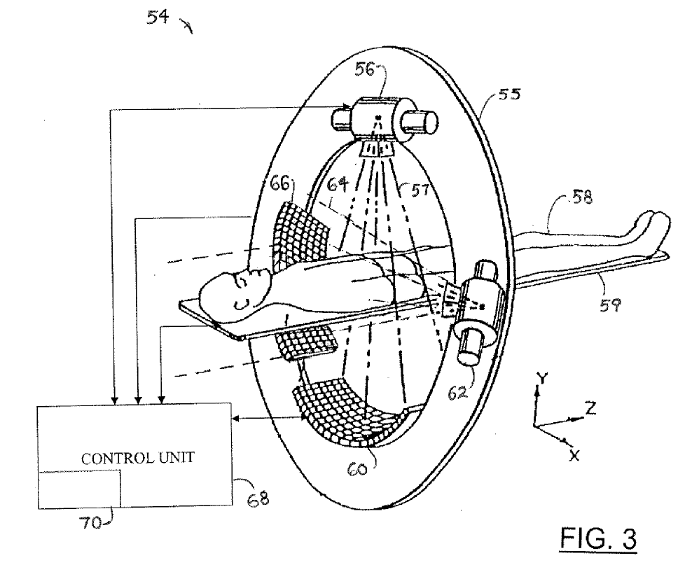

Referring to FIG. 3, a scatter radiation compensation imaging system 54 for a computed tomography (CT) system, including a gantry 55, is illustrated in accordance with another embodiment of the present invention.

The computed tomography system includes a first x-ray source 56, coupled to the gantry 55, generates a first x-ray flux 57, which passes through an object 58 on the table 59 and produces first scatter radiation. The system further includes a first CT detector 60, coupled to the gantry 55, which generates a detector signal in response to x-ray flux and scatter signals.

A second x-ray source 62, also coupled to the gantry 55, generates a second x-ray flux 64, which passes through the object 58 and produces second scatter radiation.

The system further includes a second CT detector 66, coupled to the gantry 55, which generates a detector signal in response to x-ray flux and scatter signals.

The system still further includes a system control unit 68, including a host computer and display 70, which functions similarly to the host computer of FIG. 1.

In other words, data is acquired and processed, and an x-ray image, for example, is presented to a CT technician through the image display and user interface while the exam is occurring. The host computer 70 needs only read the primary and scatter signals and update the display at the appropriate locations through, for example, an image detection controller. The host computer 70 alternately stores image data in a mass storage unit for future reference.

The method for compensation for the aforementioned scatter signals is discussed in detail with regard to FIGS. 4 and 5.

Regarding the block diagram 50 of FIG. 5, with reference to the timing diagram 49 of FIG. 4, an imaging sequence method is illustrated. Important to note is that the order of the following operations is merely illustrative of one example of one set of timing steps included in the present invention. Numerous alternate block diagrams including the following steps in different orders are also embodied herein, as one skilled in the art will readily understand.

The block diagram 50 includes the timing diagram 49, which is a section from the middle of a bi-plane imaging series included to illustrate a possible set of steps included in the present invention.

Logic starts in operation block 90 when the first x-ray source generates the first x-ray plane exposure 93 and resultant scatter 96 in the second plane.

In operation block 94, the second detector system detects first plane scatter 96.

In operation block 98, a scatter readout 100 is generated by the second detector system.

In operation block 102, the second plane scatter correction formation algorithm 104 activates and generates a first compensation signal to compensate for the first plane scatter 96.

In operation block 106, the second plane scatter correction memory 108 receives the first compensation signal and stores it for retrieval during scatter correction operations.

In operation block 110 subsequent second plane x-rays 112 and image readouts 114 are generated.

In operation block 116, the second plane scatter correction algorithm 118 receives the stored scatter compensation signal and the subsequent image readouts. In operation block 120, for each image readout, the second plane scatter correction algorithm 118 generates a second plane display 121. One skilled in the art will realize that numerous possible compensation algorithms, such as a simple subtraction method, may be used to reduce or eliminate scatter from an image signal.

In operation block 122, the second x-ray source scans the second x-ray plane 124, generating a second x-ray flux 126 and second image readout 128. The first x-ray source generates a third x-ray flux 130 and image readout 132. The second x-ray source then generates a fourth x-ray flux 134 and fourth image readout 136.

In operation block 138 the first detector detects scatter 140 from the fourth x-ray flux 134 in the first image plane 92.

In operation block 142, a scatter readout 144 is generated by the first detector system.

In operation block 148, the first plane scatter correction formation algorithm 150 activates and generates a second compensation signal to compensate for the second plane scatter 140.

In operation block 152, the second plane scatter correction memory 154 receives the second compensation signal and stores it for retrieval during scatter correction operations.

In operation block 156 subsequent first plane x-rays 158 and image readouts 160 are generated.

In operation block 162, the first plane scatter correction algorithm 164 receives the stored scatter compensation signal and the subsequent image readouts. In operation block 166, for each image readout, the first plane scatter correction algorithm 164 generates a first plane display 166.

In operation, a method for scatter correction during simultaneous bi-plane imaging includes generating a first x-ray flux in a first imaging plane, generating a first image readout, and digitally sampling a first scatter signal from the first x-ray flux in a second imaging plane. A first compensation signal is generated for the first scatter signal.

One embodiment of the present method includes activating a first scatter image formation algorithm, then generating the first compensation signal, and storing the first compensation signal in a first scatter correction memory.

A second x-ray flux is generated in the second imaging plane, and a second image readout is generated, and scatter is compensated for in the second image readout with the first compensation signal.

A third x-ray flux is generated in the first imaging plane; a third image readout is also generated. A fourth x-ray flux is generated in the second imaging plane, and a fourth image readout is generated therefrom. A second scatter signal is digitally sampled from the fourth x-ray flux in the first imaging plane, and a second compensation signal is generated for the second scatter signal.

Alternate embodiments of the present invention include the sampling of scatter from any of the x-ray flux or image readouts from the second image plane.

A fifth x-ray flux is generated in the first imaging plane, and a fifth image readout is generated therefrom. Scatter in the fifth image readout is compensated for with the second compensation signal.

A first scatter correction algorithm is activated in response to the second image readout and the first compensation signal, and a first image display is generated from the first scatter correction algorithm.

The first image display is periodically updated through stopping a current exposure in the second imaging plane and reading a scatter image update resulting from an exposure in the first plane.

A second scatter correction algorithm is activated in response to the fifth image readout and the second compensation signal, and a second image display is generated from the second scatter correction algorithm.

The host computer cycles typical image processing steps in response to the detector and scatter signals, as will be understood by one skilled in the art. In other words, data offsets are corrected and x-ray dosage is measured and normalized. Necessary calibration corrections are made, and the resulting signal is filtered, typically through a low dose filter and an adaptive filter, to reduce noise in the signal. The signal is then converted to display pixel format and subsequently displayed.

From the foregoing, it can be seen that there has been brought to the art a new scanning system. It is to be understood that the preceding description of one embodiment is merely illustrative of some of the many specific embodiments that represent applications of the principles of the present invention and uses thereof.

For example, present invention includes applications in a broad range of object scanners (e.g. belt and bed scanners) for use to scan baggage, packages, vehicles, liquids, mail, etc. Furthermore, the invention permits the creation of data image data files representative of improved images. These data files are configured for transmission over networks (internet, wide and local area networks, etc) to perform a broad range of functions such as medical treatment and billing, security management, image archiving, patient care and payment tracking, etc.

Numerous and other arrangements would be evident to those skilled in the art without departing from the scope of the invention as defined by the following claims.

What is claimed is:

1. A method for scatter correction during simultaneous bi-plane imaging comprising:
generating a first x-ray flux in a first imaging plane;
generating a first image readout;
digitally sampling a first scatter signal from said first x-ray flux in a second imaging plane; and
generating a first compensation signal for said first scatter signal.

2. The method of claim 1 wherein generating a first compensation signal further comprises activating a first scatter image formation algorithm;
generating said first compensation signal; and
storing said first compensation signal in a first scatter correction memory.

3. The method of claim 1 further comprising generating a second x-ray flux in said second imaging plane;
generating a second image readout; and
compensating for scatter in said second image readout with said first compensation signal.

4. The method of claim 3 further comprising generating a third x-ray flux in said first imaging plane;
generating a third image readout;
generating a fourth x-ray flux in said second imaging plane;
generating a fourth image readout;
digitally sampling a second scatter signal from said fourth x-ray flux in said first imaging plane; and
generating a second compensation signal for said second scatter signal.

5. The method of claim 4 further comprising generating a second digital scatter readout;
generating a fifth x-ray flux in said first imaging plane;
generating a fifth image readout; and
compensating for scatter in said fifth image readout with said second compensation signal.

6. The method of claim 5 further comprising activating a first scatter correction algorithm in response to said second image readout and said first compensation signal; and
generating a first image display from said first scatter correction algorithm.

7. The method of claim 6 further comprising periodically updating said first image display through stopping a current exposure in said second imaging plane and reading a scatter image update resulting from an exposure in said first plane.

8. The method of claim 5 further comprising activating a second scatter correction algorithm in response to said fifth image readout and said second compensation signal; and
generating a second image display from said second scatter correction algorithm.

9. A method for scatter correction during simultaneous bi-plane imaging comprising:
generating a first x-ray flux in a first imaging plane;
generating a first image readout;
digitally sampling a first scatter signal from said first x-ray flux in a second imaging plane;
generating a first compensation signal for said first scatter signal;
generating a second x-ray flux in said second imaging plane;
generating a second image readout; and
compensating for scatter in said second image readout with said first compensation signal.

10. The method of claim 9 further comprising generating a third x-ray flux in said first imaging plane; and
generating a third image readout.

11. The method of claim 10 further comprising generating a fourth x-ray flux in said second imaging plane;
generating a fourth image readout;
digitally sampling a second scatter signal from said fourth x-ray flux in said first imaging plane; and
generating a second compensation signal for said first scatter signal.

12. The method of claim 11 further comprising generating a second digital scatter readout;
generating a fifth x-ray flux in said first imaging plane;
generating a fifth image readout; and
compensating for scatter in said fifth image readout with said second compensation signal.

13. The method of claim 12 further comprising activating a first scatter correction algorithm in response to said second image readout and said first compensation signal; and
generating a first image display from said first scatter correction algorithm.

14. The method of claim 13 further comprising periodically updating said first image display through stopping a current exposure in said second imaging plane and reading a scatter image update resulting from an exposure in said first plane.

15. The method of claim 12 further comprising activating a second scatter correction algorithm in response to said fifth image readout and said second compensation signal; and
generating a second image display from said second scatter correction algorithm.

16. A scanning system comprising:
a gantry;
a first x-ray source coupled to said gantry, said first x-ray source adapted to generate a first x-ray flux and a first plane scatter signal;
a second x-ray source coupled to said gantry, said second x-ray source adapted to generate a second x-ray flux and a second plane scatter signal;
a first x-ray detector system coupled to said gantry, said first x-ray detector system adapted to generate a first detector signal in response to said first x-ray flux and further adapted to generate a first scatter signal in response to said second plane scatter signal;
a second x-ray detector system coupled to said gantry, said second x-ray detector system adapted to generate a second detector signal in response to said second x-ray flux and further adapted to generate a second scatter signal in response to said first plane scatter signal; and
a host computer adapted to receive said first detector signal, said second detector signal, said first plane scatter signal, and said second plane scatter signal, said host computer further adapted to digitally sample said first plane scatter signal, generate a first image readout in response thereto, generate a first compensation signal for said first scatter signal, and store said first compensation signal in a first scatter correction memory.

17. The system of claim 16 wherein said host computer is further adapted to generate a second image readout, and compensate for scatter in said second image readout with said first compensation signal.

18. The system of claim 17 wherein said first x-ray source is further adapted to generate a third x-ray flux in said first imaging plane, and said second x-ray source is further adapted to generate a fourth x-ray flux in said first imaging plane, and wherein said host computer is further adapted to digitally sample a second scatter signal from said fourth x-ray flux in said first imaging plane, and generate a second compensation signal for said first scatter signal.

19. The system of claim 16 further comprising generating a second digital scatter readout, wherein said first x-ray source is further adapted to generate a fifth x-ray flux in said first imaging plane, wherein said host computer is further adapted to generate a fifth image readout, and compensate for scatter in said fifth image readout with said second compensation signal.

20. The system of claim 19 wherein said host computer is further adapted to activate a first scatter correction algorithm in response to said second image readout and said first compensation signal; and
generate a first image display from said first scatter correction algorithm.

21. An x-ray image data file representative of internal portions of an object, the file comprising:
first digital data representative of internal portions of the object when exposed to a first x-ray source;
second digital data representative of internal portions of the object when exposed to a second x-ray source substantially simultaneously with exposure to the first x-ray source, wherein the first x-ray source is displaced from the second x-ray source, the first digital data has been modified to compensate for scattered radiation from the second x-ray source and the second digital data has been modified to compensate for scattered radiation from the first x-ray source; and
third digital data representative of a characteristic of the object.

22. The data file of claim 21, wherein said first and second digital data is generated by respective digital x-ray detectors and is representative of at least one image of the object.

23. The data file of claim 22, wherein the object is a person and said third digital data is representative of at least one of the person's name, identification number or physical condition.

24. The data file of claim 23, wherein said first and second digital data is generated when said first and second x-ray sources are located at least three positions relative to the patient, and three positions define an arc.

25. The data file of claim 24, wherein said arc has a fixed radius.

26. The data file of claim 23, wherein said first and second digital data is generated when said first and second x-ray sources are located at least three positions relative to the patient, and three positions are located along a straight line.

27. The data file of claim 25, wherein said arc has an infinite radius.

28. The data file of claim 23, wherein at least one image is of the person's chest cavity.

29. A method of generating revenue comprising:
generating a first digital data representative of internal portions of an object when exposed to a first x-ray source;
generating a second digital data representative of internal portions of an object when exposed to a second x-ray source substantially simultaneously with exposure to said first x-ray source, wherein said first digital data has been modified to compensate for scattered radiation from said second x-ray source and said second digital data has been modified to compensate for scattered radiation from said first x-ray source;
generating a third digital data representative of a characteristic of said object; and
generating a request for a payment of money based upon at least said third digital data.

30. The method of claim 29, wherein said first and second digital data is generated by respective digital x-ray detectors and is representative of at least one image of said object.

31. The method of claim 30, wherein said object is a person and said third digital data is representative of at least one of the person's name, identification number or physical condition.

32. The method of claim 31, wherein generating said first and second digital data includes at least the step of exposing a person's chest cavity to said first and second x-ray sources.

33. The method of claim 29, wherein generating said first and second digital data includes:
generating first scatter data representative of radiation scattered from said first x-ray source when said second x-ray source is not radiating x-rays;
generating second scatter data representative of radiation scattered from said second x-ray source when said first x-ray source is not radiating x-rays;
performing said compensation of said first digital data based on said second scatter data; and
performing said compensation of said second digital data based on said first scatter data.

34. The method of claim 32, wherein generating said first and second digital data includes:
generating first scatter data representative of radiation scattered from said first x-ray source when said second x-ray source is not radiating x-rays;
generating second scatter data representative of radiation scattered from said second x-ray source when said first x-ray source is not radiating x-rays;
performing said compensation of said first digital data based on said second scatter data; and
performing said compensation of said second digital data based on said first scatter data.

35. The method of claim 34, further comprising the step of transmitting said first, second and third digital data over a computer network.

36. The method of claim 35, wherein said computer network is the internet.

37. The method of claim 36, wherein said computer network is one of a wide-area computer network or a local-area computer network.

38. The method of claim 24, further comprising storing said first, second and third digital data in reference to said request for payment and data representative of payments associated with said request for payment.

39. The method of claim 38, further comprising determining a service charge associated with said request for payment.

40. A system for imaging internal portions of an object comprising:
a first radiation source;
a second radiation source displaced from said first radiation source;
a first digital detector supported relative to said first radiation source to generate first digital data representative of the object when exposed to a first radiation source;
a second digital detector supported relative to said second radiation source to generate second digital data representative of the object when exposed to a second radiation source substantially simultaneously with exposure to said first radiation source, wherein said first digital detector selectively generates first scatter data representative of radiation scattered from said first radiation source when said second radiation source is not radiating x-rays and second scatter data representative of radiation scattered from said second radiation source when said first x-ray source is not radiating radiation; and
a digital data processor coupled to said detectors to modify said first digital data with said second scatter data to compensate for scattered radiation from said second radiation source and to modify said second digital data with said first scatter data to compensate for scattered radiation from said first radiation source.

41. The system of claim 40, wherein said data processor is further configured to store third digital data representative of a characteristic of the object.

42. The system of claim 41, wherein said characteristic is one of an object type, an object name, an object location, an object destination, an object identification number, an object owner, an object source or an object shape.

43. The system of claim 40, further comprising a human viewable display for generating an image associated with said modified first and second digital data.

44. The system of claim 43, further comprising a conveyor for supporting an object, and the object is one of baggage, packages, liquid containers or envelopes.

45. The system of claim 43, wherein the object may be a vehicle and said radiation sources and detectors are supported relative to a vehicle imaging location.

46. The system of claim 43, wherein said data processor is further configured to store third digital data representative of a characteristic of the object, and the object is a person.

47. The system of claim 46, wherein said viewable display is configured to further generate alphanumeric or graphical images representative of said characteristic simultaneously with the image.

48. The system of claim 47, wherein said characteristic is one of a name, age, weight, identification number, location, view, or physical condition of the person.

49. The system of claim 48, further comprising a gantry for moving said radiation sources relative to the patient.

50. The system of claim 49, further comprising a network interface coupled to said processor for communicating first, second and third digital data over a network.
